(19) United States
(12) Patent Application Publication
(10) Pub. No.: US 2007/0012046 A1
(43) Pub. Date: Jan. 18, 2007

(54) GAS TURBINE INTERMEDIATE STRUCTURE AND A GAS TURBINE ENGINE COMPRISING THE INTERMEDIATE STRUCTURE

(75) Inventors: Jonas Larsson, Trollhattan (SE); Linda Strom, Trollhattan (SE)

Correspondence Address: NOVAK DRUCE & QUIGG, LLP, 1300 EYE STREET NW, 400 EAST TOWER, WASHINGTON, DC, 20005, US

(73) Assignee: VOLVO AERO CORPORATION, Trollhattan (SE)

(21) Appl. No.: 11/163,172

(22) Filed: Oct. 7, 2005

Related U.S. Application Data
(60) Provisional application No. 60/522,505, filed on Oct. 7, 2004.

(51) Int. Cl. F02C 7/00

(52) U.S. Cl. 60/791; 60/805

(57) ABSTRACT

The invention relates to a gas turbine intermediate structure (14) for being arranged between a first and a second gas turbine structure (8 and 9) in an axial direction (18) of a gas turbine (1). The intermediate structure (14) comprises an gas duct (5c) arranged for guiding a gas flow from a gas duct (5a) in the first structure (8) to a gas duct (5b) in the second structure (9). An inlet (19) of the intermediate structure gas duct (5c) is substantially displaced in a radial direction in relation to an outlet (20) of the intermediate structure gas duct (5c). At least one guide vane (28,29) is arranged in the intermediate structure gas duct (5c) for guiding the gas flow.

### CROSS-REFERENCE TO RELATED APPLICATIONS

The present patent application claims the benefit of U.S. Provisional Application No. 60/522,505 filed 7 Oct. 2005. Said application is expressly incorporated herein by reference in its entirety.

### FIELD OF THE INVENTION

The present invention relates to a gas turbine intermediate structure for being arranged between a first and a second gas turbine structure in an axial direction of a gas turbine, the intermediate structure comprises a gas duct arranged for guiding a gas flow from a gas duct in the first structure to a gas duct in the second structure. The invention also relates to a gas turbine engine comprising the intermediate structure.

The gas turbine engine is especially designed for an aircraft jet engine. Jet engine is meant to include various types of engines, which admit air at relatively low velocity, heat it by combustion and shoot it out at a much higher velocity. Accommodated within the term jet engine are, for example, turbojet engines and turbo-fan engines. The invention will below be described for a turbo-fan engine, but may of course also be used for other engine types.

The gas turbine engine comprises a compressor section for compressing admitted air, a combustor for combustion of the compressed air and a turbine section for expansion of the combusted gas. The turbine section comprises a plurality of turbines and is arranged to drive a plurality of compressors in the compressor section via one or a plurality of engine shafts.

The gas turbine intermediate structure in question may be applied in the compressor section between a low-pressure compressor structure and a high-pressure compressor structure.

The gas turbine intermediate structure in question may further be applied in the turbine section between a low-pressure turbine structure and a high-pressure turbine structure.

For some engine configurations it is desirable if the intermediate structure gas duct can have a large radial displacement and allow for large diffusion/area-increase. This would increase engine efficiency and performance. It is of course also good to make the intermediate structure gas duct as short as possible in the axial direction in order to reduce engine length & weight. These three demands make it difficult to design the intermediate structure gas duct with good aerodynamic characteristics and to keep losses low and give the downstream structure a good inflow. The intermediate structure gas duct cannot be too aggressive in terms of having a short axial length, a large radial shift and a large diffusion. A too aggressive duct might separate the gas flow and create large losses and flow distortions into the downstream second structure.

### SUMMARY OF THE INVENTION

The purpose of the invention is to increase the capability of a gas turbine intermediate structure to handle large radial displacement of the gas duct, large diffusion of the gas duct and/or to allow for a shorter gas duct while maintaining or improving the aerodynamic function of the gas duct.

This purpose is achieved in that an inlet of the intermediate structure gas duct is substantially displaced in a radial direction in relation to an outlet of the intermediate structure gas duct and that at least one guide vane is arranged in the intermediate structure gas duct for guiding the gas flow.

A carefully prepared design of and position of one or several such guide vanes may further improve the outlet profile of the flow out from an aggressive intermediate structure gas duct and thereby give the downstream second structure a better inflow with reduced distortions.

According to a preferred embodiment the guide vane is arranged in the vicinity of a curved portion of a wall defining the gas duct. The presence of such a guide vane creates conditions for limiting boundary layer separation from the adjacent gas duct wall.

According to a further development of the last-mentioned embodiment, an outer guide vane is arranged at a smaller distance from the radial outer gas duct wall than from the radial inner gas duct wall of the intermediate structure gas duct and an inner guide vane is arranged at a smaller distance from the radial inner gas duct wall than from the radial outer gas duct wall of the intermediate structure gas duct. By arranging the outer guide vane in the vicinity of a convex curvature of the outer gas duct wall and the inner guide vane in the vicinity of a convex curvature of the inner gas duct wall, a specifically good inflow with reduced distortions may be achieved in the downstream second structure.

According to a preferred embodiment, the intermediate structure comprises a plurality of radial struts for transmission of load, the struts extending through the gas duct, and that the guide vane is fastened to at least one of said radial struts. One benefit of using a guide vane, or wing, in an intermediate structure gas duct with such struts is that it can reduce secondary flows and help keep secondary vortices close to the endwalls, where they produce less blockage and generate less losses.

### BRIEF DESCRIPTION OF THE DRAWINGS

The invention will be explained below, with reference to the embodiments shown on the appended drawings, wherein

FIG. 1 diagrammatically shows a turbofan aircraft engine in a side view,

FIG. 2 shows an enlarged view of an intermediate compressor structure from FIG. 1,

FIG. 3 shows a diagrammatical view of a cross section along line A-A of the intermediate compressor structure in FIG. 2, and

FIG. 4 shows an enlarged view of an intermediate turbine structure from FIG. 1.

### DETAILED DESCRIPTION OF A PREFERRED EMBODIMENT OF THE INVENTION

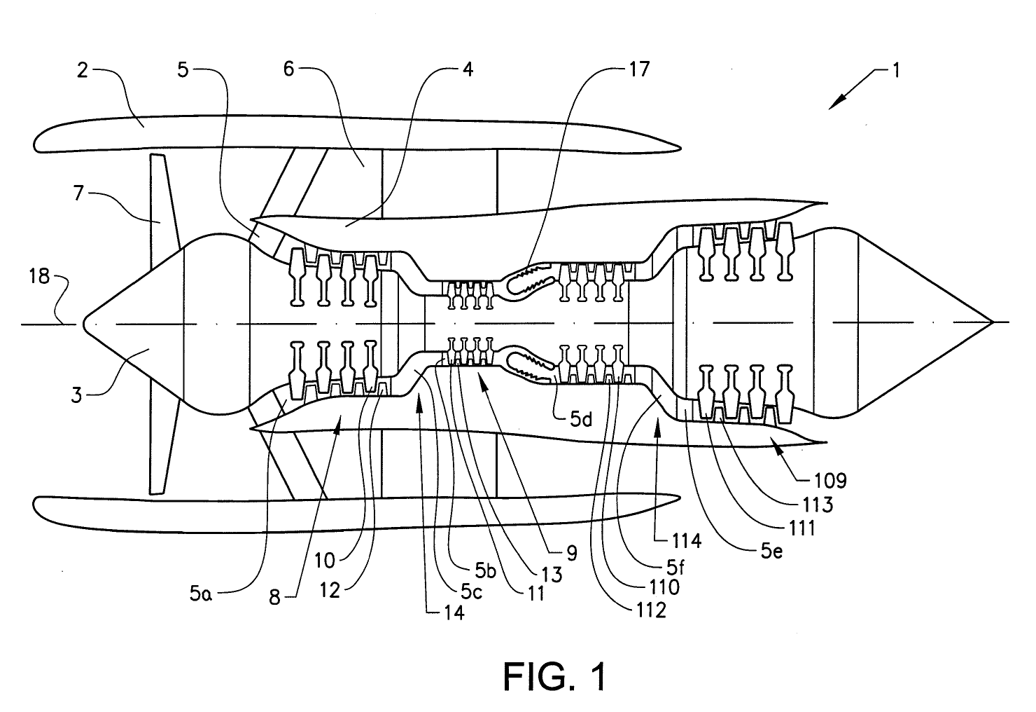

The invention will below be described for a high bypass ratio aircraft engine 1, see FIG. 1. The engine 1 comprises an outer housing or nacelle 2, an inner hub 3 and an intermediate shroud 4 which is concentric to the outer housing and the hub and divides the gap between them into an inner primary gas channel 5 for guiding the propulsion gases and a secondary channel 6 in which the engine bypass circulates. Thus, each of the gas channels 5,6 is annular in a cross section perpendicular to an axial direction 18 of the engine 1. A fan 7 is arranged at the engine intake upstream of the inner and outer gas channels 5,6.

The engine 1 comprises a first gas turbine structure 8 in the form of a low pressure compressor section and a second gas turbine structure 9 in the form of a high pressure compressor section. Each of the low pressure compressor section 8 and the high pressure compressor section 9 comprises a gas duct 5a and 5b, respectively.

Each of the compressor sections 8,9 comprises a plurality of rotors 10,11 and stators 12, 13. Every other component is a stator 12,13 and every other component is a rotor 10,11. Each of the stators 12,13 comprises a plurality of aerodynamic vanes for turning a swirling gas flow in the gas duct 5 from an upstream rotor to a substantially axial direction.

An axially intermediate structure 14 is arranged between the first and second structure 8,9 and attached to each of them. Thus, the intermediate structure 14 is adjacent both the first and second structure 8,9. The intermediate structure 14 comprises an annular gas duct 5c arranged for guiding the gas flow from the first structure gas duct 5a to the second structure gas duct 5b thereby forming a continuous gas channel through the first, intermediate and second structures 8,14,9. Thus, the gas ducts 5a, 5c and 5b of the first, intermediate and second structures 8,14,9 forms a part of said primary gas channel 5.

Thus, the gas turbine compressor structures 8,14,9 form a compressor system arranged for compression of the gas in the primary gas channel 5. A combustion chamber 17 is arranged downstream of the high pressure compressor section 9 for combustion of the compressed gas from the primary gas channel 5.

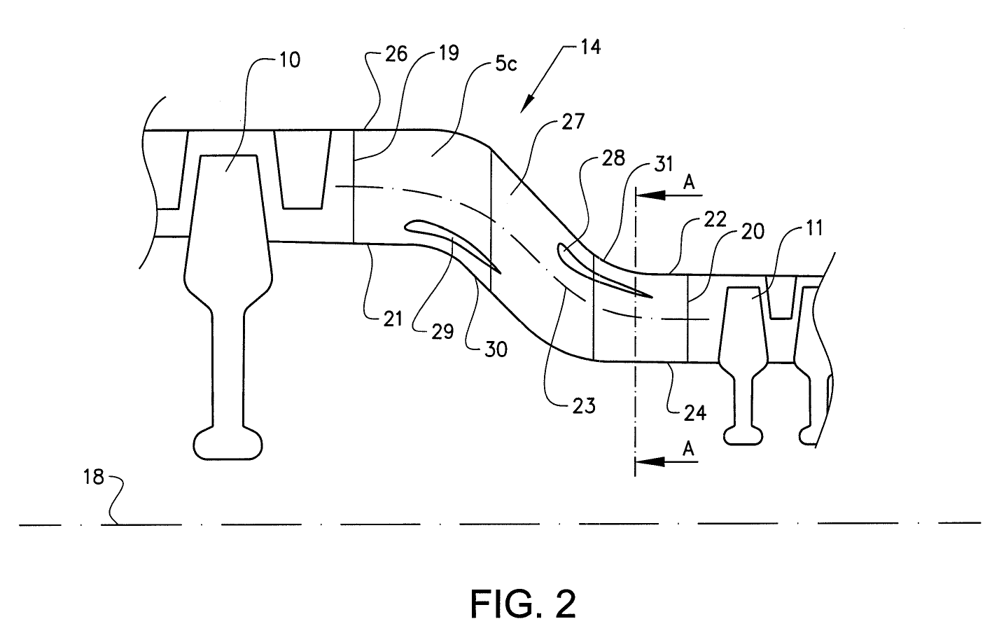

The intermediate structure gas duct 5c has an aggressive design, i.e. it has a large radial displacement between an inlet 19 to an outlet 20 in a short axial distance. Thus, the inlet 19 of the intermediate structure gas duct 5c is therefore substantially displaced in a radial direction in relation to the outlet 20 of the intermediate structure gas duct 5c, see FIG. 2. The gas duct 5c is sharply curved radial inwards from a direction substantially in parallel with the axial direction 18 at the inlet 19 and then curved outwards again to a direction substantially in parallel with the axial direction 18.

In the embodiment shown in FIG. 2, a radial inner wall 21 of the inlet 19 of the intermediate structure gas duct 5c is arranged at about the same radial distance as a radial outer wall 22 of the outlet 20 of the intermediate structure gas duct. Further, the length of the intermediate structure 14 in the axial direction is less than five times, preferably less than four times, advantageously less than three times and especially about two times the radial distance between a gas duct center line 23 at the inlet 19 and the outlet 20.

The radial distance between the walls defining the gas duct 5c at the outlet 20 is about the same as, or larger than, the radial distance between the walls defining the gas duct 5c at the inlet 19. This creates conditions for a large area increase (diffusion) of the duct 5c between the inlet 19 and the outlet 20 in cross sections perpendicular to the axial direction.

The strong curvature of a gas duct inner wall portion 30 as it turns radial inwards, see FIG. 2, would lead to a deep dip in static pressure along the inner wall where the flow accelerates around the convex portion 30. This pressure-dip would give rise to a strong and long negative pressure gradient that would cause the boundary layer to thicken and eventually separate, which would give the duct a poor performance. This problem is solved, or at least reduced, by virtue of arranging a guide vane, or wing, 29 in the vicinity of the curved portion 30 of the inner wall, which forms a part of the hub 3, in the intermediate structure gas duct. The guide vane 29 extends in a circumferential direction of the aircraft engine 1. The guide vane 29 is continuous and forms an annular vane.

The radial inner vane 29 is arranged in the intermediate structure gas duct 5c and adapted to carry aerodynamic load in an axial-radial plane for guiding and turning the gas flow, see FIG. 2. Thus, the vane 29 is arranged in such a way that downstream flow distorsions are suppressed. The vane 29 is thin and aerodynamically shaped. The vane 29 is preferably airfoil-shaped.

More specifically, the radial inner guide vane 29 is arranged in the vicinity of and substantially in parallel to the inwardly convex curved portion 30 of the inner wall defining the gas duct 5c. In this way, boundary layer separation from the inner gas duct wall is suppressed.

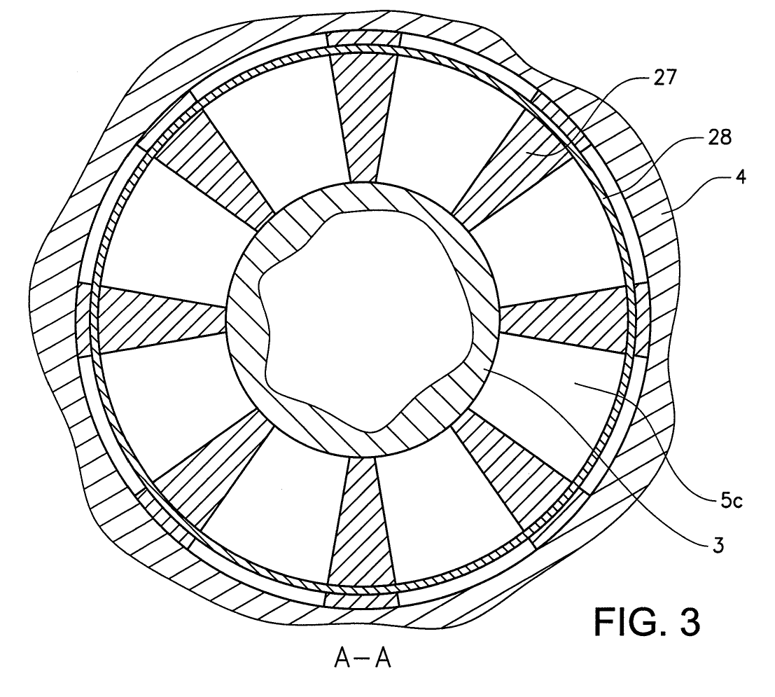

One radial outer annular vane, or wing, 28 is arranged in the intermediate structure gas duct 5c and adapted to carry aerodynamic load in an axial-radial plane for guiding and turning the gas flow, see FIGS. 2 and 3. This second annular vane 28 has a similar functionality for the shroud 4 as the first vane 29 has for the hub 3. The second wing 28 helps turn the flow along the convex curvature of a gas duct outer wall portion 31, which forms part of the shroud 4. Thus, the vane 28 is arranged in such a way that downstream flow distorsions are suppressed. The guide vane 28 extends in a circumferential direction of the aircraft engine 1. The guide vane 28 is continuous and forms an annular vane. The vane 28 is thin and aerodynamically shaped. The vane 28 is preferably airfoil-shaped.

The first annular vane 29 that is used to help turn the flow along the hub 3 actually makes the negative pressure gradient larger in the problematic convex part 31 of the shroud 4. The second vane 28 is in this design placed just upstream of where separation would occur on the shroud 4. This reduces the negative pressure gradient in this region and the boundary layer. This greatly improves the performance of the duct.

Thus, the radial outer guide vane 28 is arranged in the vicinity of and substantially in parallel to the inwardly convex curved portion 31 of the outer wall defining the gas duct 5c. In this way, boundary layer separation from the outer gas duct wall is suppressed.

The intermediate structure 14 connects the hub 3 and the shroud 4 by a plurality of radial arms 27 at mutual distances in the circumferential direction of the compressor intermediate structure 14, see diagrammatical presentation in FIG. 3. These arms 27 are generally known as struts. The struts 27 are designed for transmission of loads in the engine. Further, the struts are hollow in order to house service components such as means for the intake and outtake of oil and/or air, for housing instruments, such as electrical and metallic cables for transfer of information concerning measured pressure and/or temperature, a drive shaft for a start engine etc. The struts can also be used to conduct a coolant.

The radial struts 27 extend through the gas duct 5c and the radial outer annular guide vane 28 is fastened to at least one of said radial struts. More specifically, the radial outer annular guide vane 28 is positioned close to a trailing edge of the struts. Further, the inner annular guide vane 29 in the intermediate compressor structure 14 is fastened close to a leading edge of at least one of said radial struts 27.

The compressor intermediate structure 14 connecting the shroud 4 and the hub 3 is conventionally referred to as an Intermediate Case (IMC) or Intermediate Compressor Case (ICC).

The aircraft engine 1 comprises a further first gas turbine structure 108 in the form of a high pressure turbine section and a further second gas turbine structure 109 in the form of a low pressure turbine section. The turbine sections 108,109 are arranged downstream of the combustion chamber 17. Each of the low pressure turbine section 108 and the high pressure turbine section 109 comprises a gas duct 5d and 5e, respectively.

Each of the compressor sections 8,9 comprises a plurality of rotors 110,111 and stators 112, 113. Every other component is a stator 112,113 and every other component is a rotor 110,111. Each of the stators 112,113 comprises a plurality of aerodynamic vanes for turning a swirling gas flow in the gas duct 5 from an upstream rotor to a substantially axial direction.

An axially intermediate structure 114 is arranged between the first and second turbine structures 108,109 and attached to them. The intermediate structure 114 comprises an annular gas duct 5f arranged for guiding the gas flow from the first turbine structure gas duct 5d to the second turbine structure gas duct 5e thereby forming a continuous gas channel through the first, intermediate and second structures 108,114,109. Thus, the gas ducts 5d, 5f and 5e of the first, intermediate and second structures 108,114,109 forms a part of said primary gas channel 5.

Thus, the gas turbine structures 108,114,109 form a turbine system arranged for expansion of the gas in the primary gas channel 5.

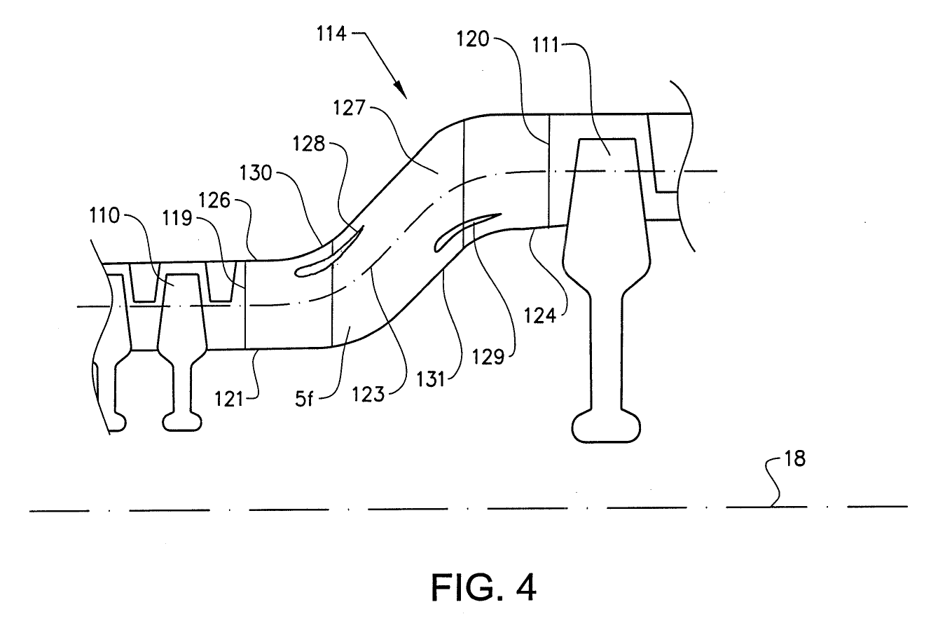

The intermediate structure gas duct 5f has an aggressive design, i.e. it has a large radial displacement between an inlet 119 to an outlet 120 in a short axial distance, see FIG. 4. Thus, the inlet 119 of the intermediate structure gas duct 5f is therefore substantially displaced in a radial direction in relation to the outlet 120 of the intermediate structure gas duct 5f. The gas duct 5f is sharply curved radial outwards from a direction substantially in parallel with the axial direction 18 at the inlet 119 and then curved inwards again to a direction substantially in parallel with the axial direction 18 at the outlet 120.

In the embodiment shown in FIG. 4, a radial outer wall 126 of the inlet 119 of the intermediate structure gas duct 5f is arranged at about the same radial distance as a radial inner wall 124 of the outlet 120 of the intermediate structure gas duct. Further, the length of the intermediate structure 14 in the axial direction is less than five times, preferably less than four times, advantageously less than three times and especially about two times the radial distance between a gas duct center line 123 at the inlet 119 and the outlet 120.

The radial distance between the walls defining the gas duct 5f at the outlet 120 is about the same as, or larger than, the radial distance between the walls defining the gas duct 5f at the inlet 119. Thus, there is a large area increase (diffusion) of the duct 5f between the inlet 119 and the outlet 120 in cross sections perpendicular to the axial direction.

The strong curvature of the shroud 4, see gas duct wall portion 130 in FIG. 4, as it turns radial outwards would lead to a deep dip in static pressure where the flow accelerates around the convex shroud 4. This pressure-dip would give rise to a strong and long negative pressure gradient that would cause the boundary layer to thicken and eventually separate. This would give the duct 5f a poor performance. This problem is solved, or at least reduced, by virtue of arranging an annular vane, or wing, 128 in the vicinity of the curved portion 130 of the outer wall, which forms a part of the shroud 4, in the intermediate structure gas duct 5f.

Thus, the radial outer annular vane 128 is arranged in the intermediate structure gas duct 5f and adapted to carry aerodynamic load in an axial-radial plane for guiding and turning the gas flow, see FIG. 4. The vane 128 is arranged in such a way that downstream flow distorsions are suppressed. The guide vane 128 extends in a circumferential direction of the aircraft engine 1. The guide vane 128 is continuous and forms an annular vane. The vane 128 is thin and aerodynamically shaped. The vane 128 is preferably airfoil-shaped.

The radial outer guide vane 128 is arranged in the vicinity of and substantially in parallel to an outwardly convex curved portion 130 of the outer wall defining the gas duct 5f. In this way, boundary layer separation from the outer gas duct wall is suppressed.

One radial inner annular vane, or wing, 129 is arranged in the intermediate structure gas duct 5c and adapted to carry aerodynamic load in an axial-radial plane for guiding and turning the gas flow, see FIG. 4. This second annular vane 129 has a similar functionality for the hub 3 as the first vane 128 has for the shroud 4. The second wing 129 helps turn the flow along the convex curvature of a gas duct inner wall portion 131, which forms part of the hub 3. Thus, the vane 129 is arranged in such a way that downstream flow distorsions are suppressed. The guide vane 129 extends in a circumferential direction of the aircraft engine 1. The guide vane 129 is continuous and forms an annular vane. The vane 129 is thin and aerodynamically shaped. The vane 129 is preferably airfoil-shaped.

The radial inner guide vane 129 is arranged in the vicinity of and substantially in parallel to an outwardly convex curved portion 131 of the inner wall defining the gas duct 5f. In this way, boundary layer separation from the inner gas duct wall is suppressed.

The radial outer annular vane 128 that is used to help turn the flow along the shroud 4 actually makes the negative pressure gradient larger in the problematic convex part of the hub. The radial inner annular vane 129 is in this design placed just upstream of where separation would occur on the hub 3. This reduces the negative pressure gradient in this region and the boundary layer. This greatly improves the performance of the duct.

The intermediate structure 114 in the turbine section connects the hub 3 and the shroud 4 by a plurality of radial struts 127 at mutual distances in the circumferential direction of the turbine intermediate structure 114 in the same way as has been described for the compressor section. The radial struts extend through the gas duct 5f and at least one of the radial outer guide vane 28 and the inner guide vane 129 is fastened to at least one of said radial struts. More specifically, the inner guide vane 129 is positioned close to a trailing edge of the struts 127, and the outer guide vane 128 is positioned close to a leading edge of the struts 127.

The wording convex curvature should be interpreted as convex inwardly in relation to the gas duct.

The invention is not in anyway limited to the above described embodiments, instead a number of alternatives and modifications are possible without departing from the scope of the following claims.

As an alternative to that the gas duct immediately upwards of the intermediate structure 14,114 is directed substantially in parallel with the axial direction 18, it may be inclined relative to the axial direction. Further, the gas duct immediately downwards of the intermediate structure 14,114 may be inclined relative to the axial direction 18.

As an alternative to the gas duct configuration shown in and described in connection with FIG. 2, the compression duct may be designed so that there is no area increase (diffusion) between the inlet and the outlet. For example, the area could be substantially constant or somewhat decreasing between the inlet and the outlet. Also in these cases, the guide vane is applicable in order to create conditions for an aggressive duct (sharply curved duct) and a short duct with a large radial displacement. In the same manner, as an alternative to the gas duct configuration shown in FIG. 4, the gas duct may be designed so that there is no area increase (diffusion) between the inlet and the outlet.

The annular vanes 28,29,128,129 may further be fastened and held in place in other ways than by means of the struts. Further, not all engines have struts.

As an alternative to the intermediate gas duct configurations described above, the radial distance between the walls defining the gas duct at the outlet may be smaller than the radial distance between the walls defining the gas duct at the inlet if the gas duct is designed with a large radial displacement of the inlet and the outlet.

As an alternative to that the invention is applied in a part of a gas turbine comprising an annular gas duct, the gas duct may have a non-axi symmetrical shape, for example a polygonal shape or aerodynamically shaped to reduce secondary flows. Further, the guide vanes may also have a non-axi symmetrical shape. Preferably, the guide vane has substantially the same cross sectional shape as the gas duct has. Further, the guide vane is not necessarily continuous in the circumferential direction, It may have one or several interruptions, thus forming a non-continuous vane structure in the circumferential direction.

As an alternative to that there are two guide vanes in the intermediate gas turbine structure, the intermediate gas turbine structure may comprise only one guide vane. This single guide vane is then preferably located at the more critical, i.e. sharper, curved portion of the gas duct.

What is claimed is:

1. Gas turbine intermediate structure (14,114) for being arranged between a first and a second gas turbine structure (8,108 and 9,109) in an axial direction (18) of a gas turbine (1), the intermediate structure (14,114) comprises a gas duct (5c,5f) arranged for guiding a gas flow from a gas duct (5a,5d) in the first structure (8,108) to a gas duct (5b,5e) in the second structure (9,109), wherein an inlet (19,119) of the intermediate structure gas duct (5c,5f) is substantially displaced in a radial direction in relation to an outlet (20,120) of the intermediate structure gas duct (5c,5f) and that at least one guide vane (28,29,128,129) is arranged in the intermediate structure gas duct (5c,5f) for guiding the gas flow.

2. Gas turbine intermediate structure according to claim 1, wherein the guide vane (28,29,128,129) is arranged in the vicinity of a curved portion (30,31,130,131) of a wall defining the gas duct (5c,5f).

3. Gas turbine intermediate structure according to claim 2, wherein the guide vane (28,29,128,129) is arranged substantially in parallel to the curved portion (30,31,130,131) of the gas duct wall.

4. Gas turbine intermediate structure according to claim 3, wherein an outer guide vane (28,128) is arranged at a smaller distance from the radial outer gas duct wall than from the radial inner gas duct wall of the intermediate structure gas duct (5c,5f).

5. Gas turbine intermediate structure according to claim 4, wherein an inner guide vane (29,129) is arranged at a smaller distance from the radial inner gas duct wall than from the radial outer gas duct wall of the intermediate structure gas duct (5c,5f).

6. Gas turbine intermediate structure according to claim 5, wherein it comprises a plurality of radial struts (27) for transmission of load, the struts extending through the gas duct (5c,5f), and that the guide vane (28,29,128,129) is fastened to at least one of said radial struts (27).

7. Gas turbine intermediate structure according to claim 6, wherein the length of the intermediate structure (14,114) in the axial direction is less than three times the radial distance between a center line (23,123) at an inlet (19,119) and at an outlet (20,120) of the intermediate structure gas duct (5c,5f).

8. Gas turbine intermediate structure according to claim 7, wherein the gas duct (5c) is curved radial inwards for being arranged between a low-pressure compressor section (8) and a high-pressure compressor section (9).

9. Gas turbine intermediate structure according to claim 7, wherein the gas duct (5f) is curved radial outwards for being arranged between a high-pressure turbine section (108) and a low-pressure turbine section (109).

10. Gas turbine engine comprising the gas turbine intermediate structure (14,114) according to claim 9.

11. Gas turbine engine according to claim 10, comprising a low-pressure compressor section (8) and a high-pressure compressor section (9)
Wherein the gas turbine intermediate structure (14) is arranged between the low-pressure compressor section (8) and the high-pressure compressor section (9).

12. Gas turbine engine according to claim 11, comprising a high-pressure turbine section (108) and a low-pressure turbine section (109)
Wherein the gas turbine intermediate structure (114) is arranged between the high-pressure turbine section (108) and the low-pressure turbine section (109).

13. Aircraft jet engine comprising the gas turbine engine (1) according to claim 12.
